(19) United States
(12) Patent Application Publication
(10) Pub. No.: US 2020/0339121 A1
(43) Pub. Date: Oct. 29, 2020

(54) SYSTEM AND METHOD FOR CONTROLLING TORQUE OF ECO-FRIENDLY VEHICLE FOR IMPROVING STEERING CONTROL PERFORMANCE

(71) Applicants: Hyundai Motor Company, Seoul (KR); Kia Motors Corporation, Seoul (KR)

(72) Inventor: Do Youn Jang, Seoul (KR)

(21) Appl. No.: 16/679,599

(22) Filed: Nov. 11, 2019

(30) Foreign Application Priority Data
Apr. 24, 2019 (KR) 10-2019-0048093

(51) Int. Cl. B60W 30/18; B60L 7/18; B60W 40/068; B60W 10/20; B60T 8/1755

(52) U.S. Cl. CPC B60W 30/18072; B60L 7/18; B60T 8/1755; B60W 30/18127; B60W 10/20; B60W 40/068

(57) ABSTRACT

A system for controlling torque of a vehicle, such as an eco-friendly vehicle, can improve steering control performance. The system includes a first controller configured to change coast regeneration torque of the vehicle according to whether wheel lock of the vehicle has occurred and whether the vehicle is steerable.

### CROSS REFERENCE TO RELATED APPLICATION

The present application claims under 35 U.S.C. § 119(a) the benefit of Korean Patent Application No. 10-2019-0048093, filed Apr. 24, 2019, the entire contents of which are incorporated by reference herein.

### BACKGROUND

### (a) Technical Field

The present disclosure relates to a system and a method for controlling torque of an eco-friendly vehicle for improving steering control performance, more particularly, to the system and method for controlling torque by which steering of the eco-friendly vehicle traveling on a low friction road surface is controlled.

### (b) Description of the Related Art

In an eco-friendly vehicle running by using an electric motor, such as a pure electric vehicle (EV), a hybrid electric vehicle (HEV), and a fuel cell vehicle (FCEV), regenerative braking is applied when braking the vehicle.

In this regenerative braking system for the eco-friendly vehicle, there is coast regeneration torque to generate (−) torque during coasting running to obtain regenerative energy and to generate a sense of deceleration. The amount of coast regeneration torque may be controlled by a paddle shift or a gear stage depending on the vehicle, and control may be made to vary the sense of deceleration or regeneration amount by making the amount thereof different. In addition, the regenerative braking system may improve fuel efficiency of a vehicle by converting the kinetic energy of the vehicle into electric energy during the braking of the vehicle, storing the energy in a battery, and reusing the energy to drive an electric motor when the vehicle is running.

Meanwhile, the energy recovered by coast regeneration torque is helpful in securing the driving range of an electric vehicle, but on a low friction road where a friction coefficient thereof is low due to rain or snow, wheel lock may occur due to a large coast regeneration torque. If wheel lock occurs, steering becomes impossible when changing a direction, and as a result, an accident may occur.

Therefore, it is necessary to develop technology to prevent an accident caused by the inability to steer a vehicle due to wheel lock caused by coast regeneration torque on a low friction road.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure proposes a system and method for controlling torque of an eco-friendly vehicle for improving steering control performance, in which when occurrence of wheel lock is detected and steering of a vehicle is determined to be impossible in a situation where the vehicle is traveling on a low friction road, coast regeneration torque of the vehicle is reduced to release wheel lock and to enable steering.

In order to achieve the above object, according to one aspect of the present disclosure, there is provided a system for controlling torque of a vehicle (e.g., an eco-friendly vehicle) for improving steering control performance, the system including: a first controller configured to change coast regeneration torque of the vehicle according to whether wheel lock of the vehicle has occurred and whether the vehicle is steerable.

The system may further include: a wheel speed sensor detecting a front wheel speed and a rear wheel speed of the vehicle; a steering angle sensor detecting a steering angle of the vehicle; a yaw rate sensor detecting a yaw rate of the vehicle; and a second controller determining whether wheel lock of the vehicle has occurred and whether the vehicle is steerable, based on information received from the wheel speed sensor, the steering angle sensor, and the yaw rate sensor.

The second controller may transmit a determination result of whether wheel lock of the vehicle has occurred and whether the vehicle is steerable to the first controller, and the first controller may change the coast regeneration torque of the vehicle according to the determination result.

The first controller may determine whether wheel lock of the vehicle has occurred and whether the vehicle is steerable based on the information received from the wheel speed sensor, the steering angle sensor, and the yaw rate sensor, and may change the coast regeneration torque of the vehicle according to a determination result.

At least one of the first controller and the second controller may include: a wheel lock detection unit detecting whether wheel lock has occurred based on a difference between the front wheel speed and the rear wheel speed of the vehicle; and a steering determination unit determining whether the vehicle is steerable based on a difference between the steering angle and the yaw rate of the vehicle.

The wheel lock detection unit may determine that wheel lock has occurred when the difference between the front wheel speed and the rear wheel speed is equal to or greater than a predetermined value.

The steering determination unit may determine that the vehicle is not steerable when the difference between the steering angle and the yaw rate is equal to or greater than a predetermined value.

When it is detected that wheel lock has occurred and it is determined that the vehicle is not steerable, the first controller may reduce the coast regeneration torque of the vehicle by a predetermined reduction rate until the coast regeneration torque reaches a predetermined value.

When the difference between the steering angle and the yaw rate is less than the predetermined value in a process of reducing the coast regeneration torque of the vehicle until the coast regeneration torque reaches the predetermined value, the first controller may control such that initially set coast regeneration torque is output.

In order to achieve the above object, according to another aspect of the present disclosure, there is provided a method for controlling torque of a vehicle for improving steering control performance, the method including: detecting whether wheel lock has occurred based on a difference between a front wheel speed and a rear wheel speed of a vehicle; determining whether the vehicle is steerable based on a difference between a steering angle and a yaw rate of the vehicle; and reducing coast regeneration torque of the vehicle when it is detected that wheel lock has occurred and it is determined the vehicle is not steerable.

In the detection of whether wheel lock has occurred, when the difference between the front wheel speed and the rear wheel speed is equal to or greater than a predetermined value, it may be determined that wheel lock has occurred.

In the determination of whether the vehicle is steerable, when the difference between the steering angle and the yaw rate is equal to or greater than a predetermined value, it may be determined that the vehicle is not steerable.

In the reduction of the coast regeneration torque of the vehicle, when it is detected that wheel lock has occurred and it is determined that the vehicle is not steerable, the coast regeneration torque of the vehicle may be reduced by a predetermined reduction rate until the coast regeneration torque reaches a predetermined value.

After the reduction of the coast regeneration torque of the vehicle, the method may further include: controlling outputting initially set coast regeneration torque when the difference between the steering angle and the yaw rate is less than the predetermined value.

Before the detection of whether wheel lock has occurred, the method may further include: detecting the front wheel speed and the rear wheel speed of the vehicle; and detecting the steering angle and the yaw rate of the vehicle.

According to the present disclosure, when occurrence of wheel lock is detected and steering of a vehicle is determined to be impossible in a situation where the vehicle is traveling on a low friction road, coast regeneration torque of the vehicle is reduced to release wheel lock and to enable steering, thereby helping to prevent accidents from occurring.

According to a further aspect of the present disclosure, a non-transitory computer readable medium containing program instructions executed by a processor can include: program instructions that detect whether wheel lock has occurred based on a difference between a front wheel speed and a rear wheel speed of a vehicle; program instructions that determine whether the vehicle is steerable based on a difference between a steering angle and a yaw rate of the vehicle; and program instructions that reduce coast regeneration torque of the vehicle when it is detected that wheel lock has occurred and it is determined the vehicle is not steerable.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a view showing a configuration of a system for controlling torque of an eco-friendly vehicle for improving steering control performance according to an embodiment of the present disclosure,

FIG. 2 is a view showing a flow of a steering control method of an eco-friendly vehicle according to an embodiment of the present disclosure, and

FIG. 3 is a view showing an improved state from a situation where steering was impossible to a situation where steering is possible by the steering control method of an eco-friendly vehicle according to an embodiment of the present disclosure.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinbelow, a system and a method for controlling torque of an eco-friendly vehicle for improving steering control performance according to exemplary embodiments of the present disclosure will be described in detail with reference to the accompanying drawings.

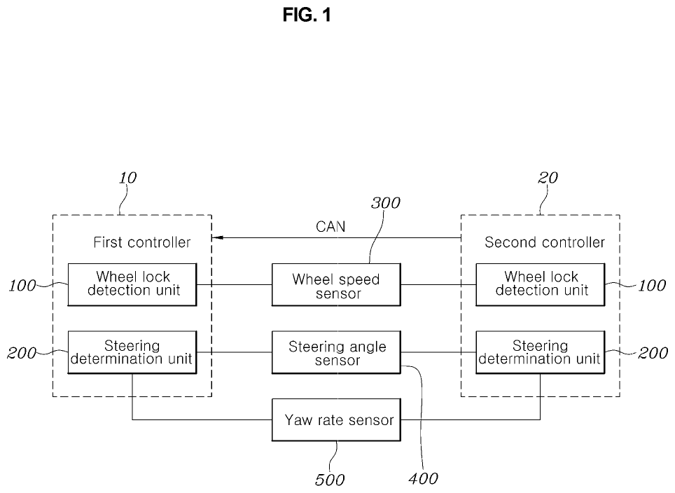

FIG. 1 is a view showing a configuration of a system for controlling torque of an eco-friendly vehicle for improving steering control performance according to an embodiment of the present disclosure. As shown in FIG. 1, the system for controlling torque of the eco-friendly vehicle for improving steering control performance according to an embodiment of the present disclosure may include a first controller 10, and may further include at least one of a wheel speed sensor 300, a steering angle sensor 400, a yaw rate sensor 500, and a second controller 20.

Herein, the wheel speed sensor 300 is mounted to the front and rear wheels of a vehicle to detect a front wheel speed and a rear wheel speed; the steering angle sensor 400 detects a steering angle of a vehicle; and the yaw rate sensor 500 detects a yaw rate of a vehicle. Since the detection of the front and rear wheel speeds, the steering angle, and the yaw rate of the vehicle by the wheel speed sensor 300, the steering angle sensor 400, and the yaw rate sensor 500 is known, a detailed description thereof will be omitted.

Meanwhile, at least one of the first controller 10 and the second controller 20 may include: a wheel lock detection unit 100; and a steering determination unit 200.

In particular, the wheel lock detection unit 100 may detect whether wheel lock has occurred based on a difference between the front wheel speed and the rear wheel speed of the vehicle detected by the wheel speed sensor 300. In particular, the wheel lock detection unit 100 may determine that wheel lock has occurred when the difference between the front wheel speed and the rear wheel speed is equal to or greater than a predetermined value. Herein, the predetermined value is a constant value that is an experimental value measured by an experiment and may be changed according to the conditions of the vehicle such as the weight and the tire thereof.

The steering determination unit 200 may determine whether the vehicle is steerable based on a difference between the steering angle of the vehicle detected by the steering angle sensor 400 and the yaw rate detected by the yaw rate sensor 500. In particular, the steering determination unit 200 may determine that the vehicle is not steerable when the difference between the steering angle and the yaw rate is equal to or greater than a predetermined value. Herein, the predetermined value is a constant value that is an experimental value measured by an experiment and may be changed depending on the type of vehicle.

The first controller 10 may change coast regeneration torque of a vehicle according to whether wheel lock of the vehicle has occurred and whether the vehicle is steerable. Depending on the embodiment, the first controller 10 may be a hybrid control unit, and a controller having the same function as the hybrid control unit may be used as the first controller 10 of the present disclosure.

In particular, depending on the embodiment, the first controller 10 may determine whether wheel lock of the vehicle has occurred and whether the vehicle is steerable based on information received from the wheel speed sensor 300, the steering angle sensor 400, and the yaw rate sensor 500, and may change the coast regeneration torque of the vehicle according to a determination result.

In addition, in another embodiment, the first controller 10 may receive the determination result information about whether wheel lock of the vehicle has occurred and whether the vehicle is steerable from the second controller 20 by using the in-vehicle communication line such as a CAN (Controller Area Network), and may change the coast regeneration torque of the vehicle based on the received information.

The second controller 20 may be a controller that can determine whether wheel lock of the vehicle has occurred and whether the vehicle is steerable based on the information received from the wheel speed sensor 300, the steering angle sensor 400, and the yaw rate sensor 500. Here, the second controller 20 may transmit the determination result information about whether wheel lock of the vehicle has occurred and whether the vehicle is steerable to the first controller 10 by using the in-vehicle communication line such as a CAN (Controller Area Network). As provided herein, the term “controller” may refer to the first controller 10 and/or the second controller 20.

Meanwhile, when it is detected that wheel lock has occurred and it is determined that the vehicle is not steerable, the first controller 10 may reduce the coast regeneration torque of the vehicle. Generally, in an eco-friendly vehicle, the energy recovered by the coast regeneration torque is helpful in securing the driving range of the vehicle, but on a low friction road where a friction coefficient thereof is low due to rain or snow, wheel lock may occur due to a large coast regeneration torque, and if wheel lock occurs, steering becomes impossible even if an attempt is made to change the direction, and as a result, an accident may occur. Thus, when the occurrence of wheel lock is detected and the steering of the vehicle is determined to be impossible in a situation where the vehicle is traveling on a low friction road, the first controller 10 of the present disclosure reduces the coast regeneration torque of the vehicle to release the wheel lock and enable steering, thereby helping to prevent accidents from occurring.

In particular, when it is detected that wheel lock has occurred and it is determined that the vehicle is not steerable, the first controller 10 may reduce the coast regeneration torque of the vehicle by a predetermined reduction rate until the coast regeneration torque reaches a predetermined value. Depending on the embodiment, when it is detected that wheel lock has occurred and it is determined that the vehicle is not steerable, the first controller 10 may reduce the coast regeneration torque of the vehicle by the reduction rate of 0.2 Nm/10 ms until the coast regeneration torque reaches 0 Nm. Herein, it is preferable to reduce the coast regeneration torque by the reduction rate of around 0.2 Nm/10 ms because discomfort may occur when the reduction rate that reduces the coast regeneration torque is too large.

Meanwhile, in a process of reducing the coast regeneration torque of the vehicle until the coast regeneration torque reaches the predetermined value as the occurrence of wheel lock is detected and the steering of the vehicle is determined to be impossible, when the difference between the steering angle detected by the steering angle sensor 400 and the yaw rate detected by the yaw rate sensor 500 is less than the predetermined value, the first controller 10 may control such that initially set coast regeneration torque is output. Herein, the fact that the difference between the steering angle detected by the steering angle sensor 400 and the yaw rate detected by the yaw rate sensor 500 is less than the predetermined value may mean that the steering of the vehicle is possible. In addition, the initially set coast regeneration torque may be the torque that is output according to the coast regeneration phase preset in the vehicle.

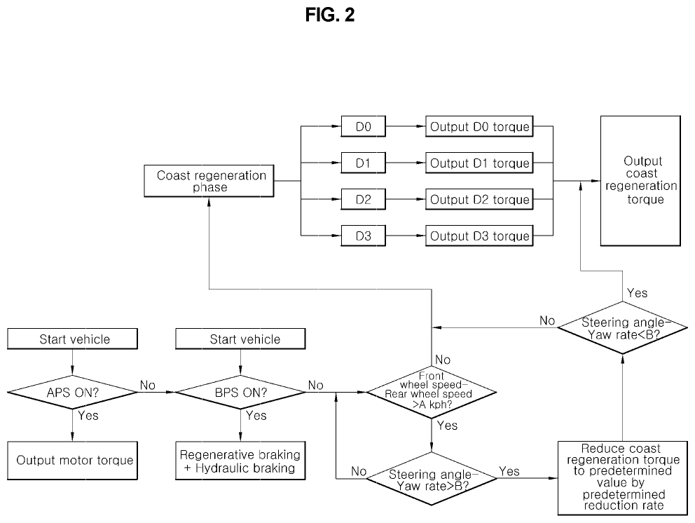

For convenience of description, a description will be given of an example of a vehicle capable of varying the coast regeneration torque in four stages from D0 to D3 through a paddle shift, with reference to FIG. 2. Here, it is assumed that the coast regeneration torque increases from D0 to D3. If the vehicle is traveling on a low friction road surface while the vehicle is set to the D3 stage, a large coast regeneration torque may cause wheel lock, which may result in the steering of the vehicle being impossible. In this situation, the first controller 10 of the present disclosure reduces the coast regeneration torque to a predetermined value by a predetermined reduction rate as described above, wherein the difference between the steering angle and the yaw rate is less than the predetermined value in the process of reducing the coast regeneration torque, which means that the steering of the vehicle becomes possible, so the coast regeneration torque corresponding to the coast regeneration stage set before reducing the coast regeneration torque may be controlled to be output. Depending on the embodiment, if the vehicle is set to the D3 stage before reducing the coast regeneration torque, when the difference between the steering angle and the yaw rate is less than the predetermined value in the process of reducing the coast regeneration torque, the first controller 10 may allow the coast regeneration torque corresponding to the predetermined D3 stage to be output.

FIG. 2 is a view showing a flow of a steering control method of an eco-friendly vehicle according to an embodiment of the present disclosure. Referring to FIG. 2, a steering control method of the eco-friendly vehicle according to an embodiment of the present disclosure may include: detection of whether wheel lock has occurred based on a difference between a front wheel speed and a rear wheel speed of a vehicle; determination of whether the vehicle is steerable based on a difference between a steering angle and a yaw rate of the vehicle; and reduction of coast regeneration torque of the vehicle when it is detected that wheel lock has occurred and it is determined the vehicle is not steerable.

In particular, in the detection of whether wheel lock has occurred, when the difference between the front wheel speed and the rear wheel speed is equal to or greater than a predetermined value, it may be determined that wheel lock has occurred.

Further, in the determination of whether the vehicle is steerable, when the difference between the steering angle and the yaw rate is equal to or greater than a predetermined value, it may be determined that the vehicle is not steerable.

In addition, in the reduction of coast regeneration torque of the vehicle, when it is detected that wheel lock has occurred and it is determined that the vehicle is not steerable, the coast regeneration torque of the vehicle may be reduced by a predetermined reduction rate until the coast regeneration torque reaches a predetermined value.

Meanwhile, before the detection of whether wheel lock has occurred, the method may further include: detection of the front wheel speed and the rear wheel speed of the vehicle; and detection of the steering angle and the yaw rate of the vehicle. In addition, after the reduction of coast regeneration torque of the vehicle, the method may further include controlling outputting initially set coast regeneration torque when the difference between the steering angle and the yaw rate is less than the predetermined value.

The detailed technical features of each step of the steering control method of an eco-friendly vehicle according to an embodiment of the present disclosure are the same as the detailed technical features of the above described system for controlling torque of the eco-friendly vehicle for improving steering control performance according to an embodiment of the present disclosure, so a detailed description thereof will be omitted.

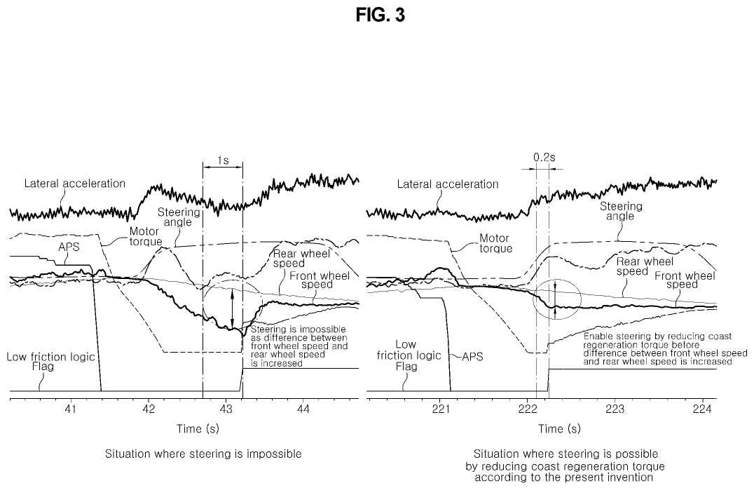

FIG. 3 is a view showing an improved state from a situation where steering was impossible to a situation where steering is possible by the steering control method of the eco-friendly vehicle according to an embodiment of the present disclosure. In particular, the left side of FIG. 3 shows a state in which wheel lock occurs and steering is impossible as the difference between the front wheel speed and the rear wheel speed is increased during traveling on a low friction road; and the right side of FIG. 3 shows a state in which the wheel lock is released by reducing the coast regeneration torque before the difference between the front wheel and the rear wheel becomes equal to or greater than a predetermined value so as to enable steering.

According to the present disclosure, if the occurrence of wheel lock is detected on a low friction road surface and it is determined that steering of the vehicle is not possible, the coast regeneration torque of the vehicle is reduced, thereby releasing the wheel lock and enabling steering to help prevent an accident form occurring.

Although the disclosure is described with reference to specific items such as specific structural elements, to merely some embodiments, and to drawings, such specific details disclosed herein are merely representative for purposes of helping more comprehensive understanding of the present disclosure. The present disclosure, however, is not limited to only the example embodiments set forth herein, and those skilled in the art will appreciate that the present disclosure can be embodied in many alternate forms.

What is claimed is:

1. A system for controlling torque of a vehicle for improving steering control performance, the system comprising:
a first controller configured to change coast regeneration torque of the vehicle according to whether wheel lock of the vehicle has occurred and whether the vehicle is steerable.

2. The system of claim 1, further comprising:
a wheel speed sensor detecting a front wheel speed and a rear wheel speed of the vehicle;
a steering angle sensor detecting a steering angle of the vehicle;
a yaw rate sensor detecting a yaw rate of the vehicle; and
a second controller determining whether wheel lock of the vehicle has occurred and whether the vehicle is steerable, based on information received from the wheel speed sensor, the steering angle sensor, and the yaw rate sensor.

3. The system of claim 2, wherein the second controller transmits a determination result of whether wheel lock of the vehicle has occurred and whether the vehicle is steerable to the first controller, and the first controller changes the coast regeneration torque of the vehicle according to the determination result.

4. The system of claim 2, wherein the first controller determines whether wheel lock of the vehicle has occurred and whether the vehicle is steerable based on the information received from the wheel speed sensor, the steering angle sensor, and the yaw rate sensor, and changes the coast regeneration torque of the vehicle according to a determination result.

5. The system of claim 2, wherein at least one of the first controller and the second controller includes:
a wheel lock detection unit detecting whether wheel lock has occurred based on a difference between the front wheel speed and the rear wheel speed of the vehicle; and
a steering determination unit determining whether the vehicle is steerable based on a difference between the steering angle and the yaw rate of the vehicle.

6. The system of claim 5, wherein the wheel lock detection unit determines that wheel lock has occurred when the difference between the front wheel speed and the rear wheel speed is equal to or greater than a predetermined value.

7. The system of claim 5, wherein the steering determination unit determines that the vehicle is not steerable when the difference between the steering angle and the yaw rate is equal to or greater than a predetermined value.

8. The system of claim 5, wherein when it is detected that wheel lock has occurred and it is determined that the vehicle is not steerable, the first controller reduces the coast regeneration torque of the vehicle by a predetermined reduction rate until the coast regeneration torque reaches a predetermined value.

9. The system of claim 8, wherein when the difference between the steering angle and the yaw rate is less than the predetermined value in a process of reducing the coast regeneration torque of the vehicle until the coast regeneration torque reaches the predetermined value, the first controller controls such that initially set coast regeneration torque is output.

10. A method for controlling torque of a vehicle for improving steering control performance, the method comprising:
detecting, by a controller, whether wheel lock has occurred based on a difference between a front wheel speed and a rear wheel speed of the vehicle;
determining, by the controller, whether the vehicle is steerable based on a difference between a steering angle and a yaw rate of the vehicle; and
reducing, by the controller, coast regeneration torque of the vehicle when it is detected that wheel lock has occurred and it is determined the vehicle is not steerable.

11. The method of claim 10, wherein in detecting whether wheel lock has occurred,
when the difference between the front wheel speed and the rear wheel speed is equal to or greater than a predetermined value, it is determined that wheel lock has occurred.

12. The method of claim 10, wherein in determining whether the vehicle is steerable,
when the difference between the steering angle and the yaw rate is equal to or greater than a predetermined value, it is determined that the vehicle is not steerable.

13. The method of claim 10, wherein in reducing the coast regeneration torque of the vehicle,
when it is detected that wheel lock has occurred and it is determined that the vehicle is not steerable, the coast regeneration torque of the vehicle is reduced by a predetermined reduction rate until the coast regeneration torque reaches a predetermined value.

14. The method of claim 10, further comprising:
after reducing the coast regeneration torque of the vehicle, controlling outputting initially set coast regeneration torque when the difference between the steering angle and the yaw rate is less than the predetermined value.

15. The method of claim 10, further comprising:
before detecting whether wheel lock has occurred,
detecting the front wheel speed and the rear wheel speed of the vehicle; and
detecting the steering angle and the yaw rate of the vehicle.

16. A non-transitory computer readable medium containing program instructions executed by a processor, the computer readable medium comprising:
program instructions that detect whether wheel lock has occurred based on a difference between a front wheel speed and a rear wheel speed of a vehicle;
program instructions that determine whether the vehicle is steerable based on a difference between a steering angle and a yaw rate of the vehicle; and
program instructions that reduce coast regeneration torque of the vehicle when it is detected that wheel lock has occurred and it is determined the vehicle is not steerable.
